(19) United States
(12) Patent Application Publication
(10) Pub. No.: US 2018/0023041 A1
(43) Pub. Date: Jan. 25, 2018

(54) CLEANING COMPOSITIONS CONTAINING A DIAMINOSTILBENE BRIGHTENER

(71) Applicant: The Procter & Gamble Company, Cincinnati, OH (US)

(72) Inventors: Ming TANG, Beijing (CN); Hongxing LIU, Beijing (CN)

(21) Appl. No.: 15/649,668

(22) Filed: Jul. 14, 2017

(30) Foreign Application Priority Data
Jul. 21, 2016 (CN) PCT/CN2016/090810

(51) Int. Cl. C11D 10/04; C11D 3/12; C11D 3/10; C11D 3/42; C11D 17/06

(52) U.S. Cl. CPC C11D 10/042; C11D 3/42; C11D 17/06; C11D 3/10; C11D 3/128; C11D 1/22

(57) ABSTRACT

A cleaning composition, preferably a granular laundry detergent composition, containing a diaminostilbene brightener in a surfactant system containing a C₁₀-C₂₀ linear alkylbenzene sulphonate (LAS), a C₆-C₁₈ unalkoxylated alkyl sulphate (AS), and fatty acids or salts thereof at specific amounts and weight ratios. Such a surfactant system results in surprisingly better dissolution of the diaminostilbene brightener in water.

### FIELD OF THE INVENTION

The present invention relates to cleaning compositions, preferably granular laundry detergent compositions.

### BACKGROUND OF THE INVENTION

Optical brighteners, also known as fluorescent whitening agents, have long be used in fabric care products to compensate for the yellow tint of fabrics by adsorbing light in the ultraviolet and violet regions and emitting light in the blue region (i.e., blue fluorescence). Such blue light is added to the light reflected by the fabric and functions to improve the whitening appearance of fabrics.

However, optical brighteners are usually not easy to dissolve in water, which in turn reduces their overall whitening efficacy. Further, when used at higher levels (e.g., to compensate for the reduced efficacy), undissolved optical brighteners can also cause localized staining of fabrics. Among different types of optical brigtheners, diaminostilbene brighteners, such as disodium 4,4′-bis{[4-anilino-6-morpholino-s-triazin-2-yl]-amino } -2,2′-stilbenedisulfonate (typically referred to as or “Florescent Brigthener 260”), have particularly poor water dissolution, in comparison with distyrylbiphenyl brighteners such as disodium 2,2′-([1,1′-biphenyl]-4,4′-diyldivinylene)bis(benzenesulphonate) (typically referred to asor “Florescent Brightener 351”).

There is therefore a need to improve dissolution of optical brighteners, particularly that of the diaminostilbene brighteners, in order to improve their whitness benefit without increasing the dosage level in fabric care products and to reduce or minimize the fabric staining issue.

### SUMMARY OF THE INVENTION

It is a surprising and unexpected discovery of the present invention that the dissolution profile of diaminostilbene brighteners can be significantly improved by combining specific surfactants at specific weight percentages and ratios.

Specifically, the present invention relates to cleaning a composition that contains: (a) from about 6 wt % to about 15 wt % of a C₁₀-C₂₀ linear alkylbenzene sulphonate (LAS); (b) from about 0.3 wt % to about 4 wt % of an alkyl sulphate (AS) having a branched or linear unalkoxylated alkyl group comprising from about 6 to about 18 carbon atoms, while the LAS-to-AS weight ratio is from about 3:1 to about 30:1; (c) from about 1.5 wt % to about 6 wt % of one or more fatty acids or salts thereof; and (d) from about 0.01 wt % to about 1 wt % of a diaminostilbene brightener.

The present invention is also related to a granular laundry detergent composition that contains: (a) from about 6 wt % to about 15 wt % of a C₁₂ linear alkylbenzene sulphonate (LAS); (b) from about 0.3 wt % to about 4 wt % of an alkyl sulphate (AS) having a branched or linear unalkoxylated alkyl group comprising from about 12 to about 14 carbon atoms, while the LAS-to-AS weight ratio is from about 3:1 to about 30:1; (c) from about 1.5 wt % to about 6 wt % of one or more saturated fatty acids or salts thereof comprising from about 12 to about 18 carbon atoms; and (d) from about 0.01 wt % to about 1 wt % of disodium 4,4′-bis{[4-anilino-6-morpholino-s-triazin-2-yl]-amino}-2,2′-stilbenedisulfonate, while such composition has a moisture content of no more than about 3 wt %.

The present invention is further related to a concentrated granular laundry detergent composition containing: (a) from about 12 wt % to about 30 wt % of a C₁₂ linear alkylbenzene sulphonate (LAS); (b) from about 0.5 wt % to about 8 wt % of an alkyl sulphate (AS) having a branched or linear unalkoxylated alkyl group comprising from about 12 to about 14 carbon atoms, while the LAS-to-AS weight ratio is from about 3:1 to about 30:1; (c) from about 4 wt % to about 12 wt % of one or more saturated fatty acids or salts thereof comprising from about 12 to about 18 carbon atoms; and (d) from about 0.05 wt % to about 2 wt % of disodium 4,4′-bis{[4-anilino-6-morpholino-s-triazin-2-yl]-amino}-2,2′-stilbenedisulfonate, while such composition has a moisture content of no more than about about 3 wt %.

These and other aspects of the present invention will become more apparent upon reading the following detailed description of the invention.

### DETAILED DESCRIPTION OF THE INVENTION

Inventors of the present invention discovered that the water dissolution of diaminostilbene fluorescent brighteners is significantly improved by formulating them with a surfactant system containing the combination of LAS, mid-chain AS (i.e., with a C₆-C₁₈, preferably C₁₂-C₁₄ branched or linear unalkoxylated alkyl group), and fatty acids. Such improvement is not observed with surfactant systems containing only LAS, or LAS with mid-chain AS, or LAS with fatty acids, even when the total surfactant level is maintained the same. Such improvement is also not observed with distyrylbiphenyl brighteners, which are another family of commonly used fluorescent brighteners.

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “cleaning composition” includes, unless otherwise indicated, granular or powder-form all-purpose or “heavy-duty” washing agents, especially cleaning detergents, for fabrics, as well as cleaning auxiliaries such as bleach, rinse aids, additives, or pre-treat types; hand dishwashing agents or light duty dishwashing agents, especially those of the high-foaming type; machine dishwashing agents; mouthwashes, denture cleaners, car or carpet shampoos, bathroom cleaners; hair shampoos and hair-rinses; shower gels and foam baths and metal cleaners; as well as cleaning auxiliaries such as bleach additives or pre-treat types. In one preferred aspect, the cleaning composition is a solid laundry detergent composition, and more preferably a free-flowing particulate laundry detergent composition (i.e., a granular laundry detergent product).

As used herein, the terms “consisting essentially of” means that the composition contains less than about 1%, preferably less than about about 0.5%, of ingredients other than those listed. Further, the terms “essentially free of,” “substantially free of” or “substantially free from” means that the indicated material is present in the amount of from 0 wt % to about 0.5 wt %, or preferably from 0 wt % to about 0.1 wt %, or more preferably from 0 wt % to about 0.01 wt %, and most preferably it is not present at analytically detectable levels. The term “substantially pure” or “essentially pure” means that the indicated material is present in the amount of from about 99.5 wt % to about 100 wt %, preferably from about 99.9 wt % to about 100 wt %, and more preferably from 99.99 wt % to about 100 wt %, and most preferably all other materials are present only as impurities below analytically detectable levels.

As used herein, the term “water-soluble” refers to a solubility of more than about 30 grams per liter (g/L) of deionized water measured at 20° C. and under the atmospheric pressure.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Diaminostilbene Brighteners

Preferably, diaminostilbene brighteners used in the present invention are characterized by molecular weights of no less than about 600 daltons. Suitable diaminostilbene brighteners include, but are not limited to the following:

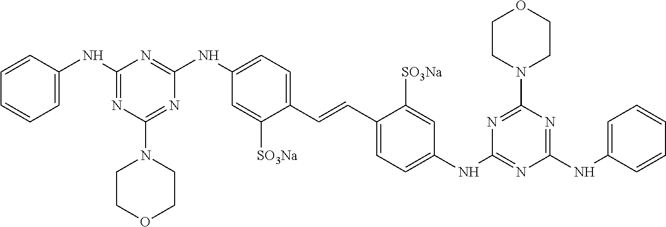

Disodium 4,4′-bis{[4-anilino-6-morpholino-s-triazin-2-yl]-amino }-2,2′-stilbenedisulfonate (“Florescent Brigthener 260”), which is available from BASF under the tradename TINOPAL® DMA (CAS No. 16090-02-1);

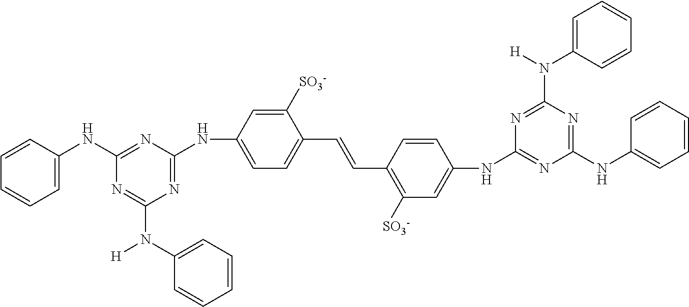

Disodium 4,4″-bis[(4,6-di -anilino-s-triazin-2-yl)-amino]-2,2′-stilbenedisulfonate; and

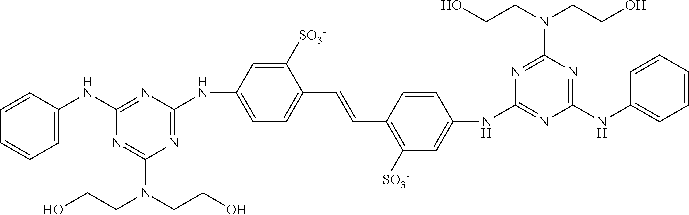

Disodium 4,4′-bis{[4-anilino-6- [bis(2-hydroxyethyl)amino-s-triazin-2-yl]-amino}-2,2′-stilbenedisulfonate.

More preferably, the diaminostilbene brightener is disodium 4,4′-bis{[4-anilino-6-morpholino-s-triazin-2-yl]-amino}-2,2′-stilbenedisulfonate (“Florescent Brigthener 260”).

The cleaning composition of the present invention may contain one or more diaminostilbene brighteners, and the total amount of diaminostilbene brighteners used in the cleaning composition of the present invention may range from about 0.01 wt % to about 1 wt %, preferably from about 0.02 wt % to about 0.5 wt %, and more preferably from about 0.05 wt % to about 0.3 wt %.

Further, the cleaning composition of the present invention may contain, in addition to the diaminostilbene brigtheners described hereinabove, one or more distyrylbiphenyl brighteners, such as disodium 2,2′-([1,1′-biphenyl]-4,4′-diyldivinylene)bis(benzenesulphonate) (typically referred to as “Florescent Brightener 351”), in the amount ranging from about 0.01 wt % to about 0.5 wt %, preferably from about 0.02 wt % to about 0.4 wt %, and more preferably from about 0.05 wt % to about 0.3 wt %. In a particularly preferred embodiment, the cleaning composition of the present invention contains from about 0.1 wt % to about 0.3 wt % of Florescent Brigthener 260 in combination with from about 0.05 wt % to about 0.2 wt % of Florescent Brightener 351.

### Surfactant System

The cleaning composition of the invention may contain a surfactant system constituted of anionic surfactants, and optionally one or more non-ionic surfactants, zwitterionic surfactants, and/or cationic surfactants.

The cleaning composition may comprise a surfactant system in the amount ranging anywhere from about 1% to about 90% by total weight of the composition. For example, the composition may comprise such a surfactant system at levels ranging from about 2% to about 50%, typically from about 4% to about 30%, or from about 6% to about 25%, or from about 8% to about 20% by weight. In a preferred embodiment of the present invention, the cleaning composition has a total surfactant level of less than about 18%, more preferably less than about 15% or 12%, and most preferably less than about 10% by total weight of the composition.

However, when the cleaninig composition is in a concentrated form, especially a concentrated powder or granular form, the total surfactant level can be significantly higher, e.g., from about 10% to about 40%, preferably from about 15% to about 30%, by total weight of the concentrated composition.

### LAS

The surfactant system of the present invention includes at least a first anionic surfactant that is a C₁₀-C₂₀ linear alkylbenzene sulphonate (LAS). LAS anionic surfactants are well known in the art and can be readily obtained by sulphonating commercially available linear alkylbenzenes. Exemplary C₁₀-C₂₀ linear alkylbenzene sulphonates that can be used in the present invention include alkali metal, alkaline earth metal or ammonium salts of C₁₀-C₂₀ linear alkylbenzene sulphonic acids, and preferably the sodium, potassium, magnesium and/or ammonium salts of C₁₁-C₁₈ or C₁₁-C₁₄ linear alkylbenzene sulphonic acids. More preferred are the sodium or potassium salts of C₁₂ linear alkylbenzene sulphonic acids, and most preferred is the sodium salt of C₁₂ linear alkylbenzene sulphonic acid, i.e., sodium dodecylbenzene sulphonate.

The amount of LAS used in the cleaning composition may range from about 6% to about 15%, preferably from about 7% to about 13%, and more preferably from about 9% to about 12%, by total weight of the composition. In a most preferred embodiment of the present invention, the cleaning composition contains from about 9 wt % to about 12 wt % of a sodium, potassium, or magnesium salt of C₁₂ linear alkylbenzene sulphonic acid.

When the cleaninig composition is in a concentrated form, especially a concentrated powder or granular form, the LAS can be present at a significantly higher level, e.g., from about 12% to about 30%, preferably from about 15% to about 25%, and more preferably from about 18% to about 24%, by total weight of the concentrated cleaning composition.

### Mid-Cut AS

The surfactant system of the present invention further includes at least a second anionic surfactant, which is an anionic alkyl sulphate (AS) surfactant having a branched or linear unalkoxylated alkyl group containing from about 6 to about 18 carbon atoms, which can be referred to as a mid-cut AS. Preferably, the mid-cut AS has the generic formula of R-O-SO₃⁻M⁺, while R is branched or linear unalkoxylated C₆-C₁₈ alkyl group, and M is a cation of alkali metal, alkaline earth metal or ammonium. More preferably, the R group of the AS surfactant contains from about 6 to about 16 carbon atoms, and more preferably from about 6 to about 14 carbon atoms. R can be substituted or unsubstituted, and is preferably unsubstituted. R is substantially free of any alkoxylation. M is preferably a cationic of sodium, potassium, or magnesium, and more preferably M is a sodium cation. Such mid-cut AS surfactant acts as a co-surfactant for the LAS.

Preferably, but not necessarily, the surfactant system of the present invention contains a mixture of C₆-C₁₈ AS surfactants, in which C₆-C₁₄ AS surfactants are present in an amount ranging from about 85% to about 100% by total weight of the mixture. This mixture can be referred to as a “C₆-C₁₄-rich AS mixture.” More preferably, such C₆-C₁₄-rich AS mixture contains from about 90 wt % to about 100 wt %, or from 92 wt % to about 98 wt %, or from about 94 wt % to about 96 wt %, or 100 wt % (i.e., pure), of C₆-C₁₄ AS.

In a particularly preferred embodiment of the present invention, the surfactant system in the cleaning composition contains a mixture of C₆-C₁₈ AS surfactants with from about 30 wt % to about 100 wt % or from about 50 wt % to about 99 wt %, preferably from about 60 wt % to about 95 wt %, more preferably from about 65 wt % to about 90 wt %, and most preferably from about 70 wt % to about 80 wt % of C₁₂ AS. Further, such mixture of C₆-C₁₈ AS surfactants may contain from about 10 wt % to about 100 wt %, preferably from 15 wt % to about 50 wt %, and more preferably from 20 wt % to about 30 wt % of C14 AS. This mixture can be referred to as a “C₁₂-C₁₄-rich AS mixture.”

In a most preferred embodiment of the present invention, the surfactant system of the cleaning composition contains a mixture of AS surfactants that consists essentially of C₁₂ and/or C₁₄ AS surfactants. For example, such mixture of AS surfactant may consist essentially of from about 70 wt % to about 80 wt % of C₁₂ AS and from 20 wt % to about 30 wt % of C₁₄ AS, with little or no other AS surfactants therein. Such mixture may also consist of substantially pure C₁₂ AS, or alternatively, substantially pure C₁₄ AS.

A commercially available AS mixture particularly suitable for practice of the present invention is Texapon® V95 G from Cognis (Monheim, Germany) Further, the surfactant system of the present invention may contain a mixture of C₆-C₁₈ AS surfactants comprising more than about 50 wt %, preferably more than about 60 wt %, more preferfably more than 70 wt % or 80 wt %, and most preferably more than 90 wt % or even at 100 wt % (i.e., substantially pure), of linear AS surfactants having an even number of carbon atoms, including, for example, C₆, C₈, C₁₀, C₁₂, C₁₄, C₁₆, and C₁₈ AS surfactants. The mixture of C₆-C₁₈ AS surfactants as described can be readily obtained by sulphonation of alcohol(s) with the corresponding numbers of carbon atoms. The required carbon chain length distribution can be obtained by using alcohols with the corresponding chain length distribution parepared either synthetically or extracted/purified from natural raw materials or formed by mixing corresponding pure starting materials. For example, the mixture of C₆-C₁₈ AS surfactants may be derived from naturally occurring triglycerides, such as those contained in palm kernel oil or coconut oil, by chemically processing such triglycerides to form a mixture of long chain alcohols and then sulphonating such alcohols to form AS surfactants. The mixture of alcohols derived from the naturally occurring triglycerides typically contain more than about 20 wt % of C₁₆-C₁₈ alcohols. A mixture containing a lower proportion of C₁₆-C₁₈ alcohols may be separated from the original mixture before the sulphonation step, in order to form the desired mixture of C₆-C₁₈ AS surfactants as described hereinabove. Alternatively, the desired mixture of C₆-C₁₈ AS surfactants can be readily obtained by separating and purifying the already formed AS mixtures. Suitable separation and purification methods include, but are not limited to: distillation, centrifugation, recrystallization and chromatographic separation.

The amount of mid-cut AS surfactants used in the cleaning composition of the present invention may range from about 0.3 wt % to about 4.0 wt %, and preferably from about 0.5 wt % to about 3 wt % by total weight of the composition. In a most preferred embodiment of the present invention, the cleaning composition contains from about 0.3 wt % to about 4.0 wt %, and preferably from about 0.5 wt % to about 3 wt % of an AS mixture consistenting essentially of C₁₂ and C₁₄ AS, e.g., such a mixture may contain from about 70 wt % to about 80 wt % of C₁₂ AS and from 20 wt % to about 30 wt % of C₁₄ AS.

When the cleaninig composition is in a concentrated form, especially a concentrated powder or granular form, the mid-cut AS can be present at a significantly higher level, e.g., from about 0.5% to about 8%, preferably from about 1% to about 5%, and more preferably from about 2% to about 4%, by total weight of the concentrated cleaning composition.

### LAS:AS Ratio

As a co-surfactant for LAS, the AS is the most effective if it is provided in the cleaning composition at an amount to render a weight ratio of LAS to AS within the range of from about 3:1 to about 30:1, preferably from about 4:1 to about 24:1, more preferably from about 4:1 to about 20:1, and most preferably from about 4:1 to about 15:1. The LAS-to-AS ratio does not vary when the cleaning composition changes from a standard form to a concentrated form.

### Alkoxylated Alkyl Sulphate

The cleaning composition of the present invention employs mid-cut AS without any alkoxylation (as described hereinabove), instead of alkylalkoxy sulphate, as a co-surfactant for LAS. Preferably, the cleaning composition of the present invention is substantially free of alkylalkoxy sulphate, especially alkylethoxy sulphate (AES). In other words, the cleaning composition of the present invention contains alkylalkoxy sulphate, or more specifically AES, in an amount ranging from 0 wt % to about 1 wt %, preferably from 0 wt % to about 0.8 wt %, or more preferably from 0 wt % to about 0.5 wt %, and most preferably at a level that is not analytically detectable. Alkylalkoxy sulphate as used herein refers to any linear or branched alkylalkoxy sulphate having a weight average degree of alkoxylation ranging from about 0.1 to about 10.

When the cleaninig composition is in a concentrated form, especially a concentrated powder or granular form, the alkylalkoxy sulphate is preferably present in an amount ranging from 0% to about 2%, preferably from about 0% to about 1.5%, and more preferably from about 0% to about 1%, by total weight of the concentrated cleaning composition.

### Fatty Acids or Salts Thereof

The surfactant system of the present invention also contains one or more fatty acids or salts thereof at a relatively high level, i.e., from about 1.5 wt % to about 6 wt %, preferably from about 1.5 wt % to about 5 wt %, and more preferably from 1.5 wt % to about 4 wt %, by total weight of the cleaning composition.

Suitable fatty acids or salts that can be used in the present invention include one or more C₁₀-C₂₂ fatty acids or alkali salts thereof. Such alkali salts include monovalent or divalent alkali metal salts like sodium, potassium, lithium and/or magnesium salts as well as the ammonium and/or alkylammonium salts of fatty acids, preferably the sodium salt. Preferred fatty acids or salts thereof for use herein contain from 10 to 20 carbon atoms, and more preferably 12 to 18 carbon atoms. In a particularly preferred embodiment of the present invention, the cleaning composition of the present invention contains from about 2.5 wt % to about 4 wt % of fatty acids or salts having from about 10 to about 20 carbon atoms, more preferably from about 12 to about 18 carbon atoms.

Exemplary fatty acids that can be used may be selected from caprylic acid, capric acid, lauric acid, myristic acid, myristoleic acid, palmitic acid, palmitoleic acid, sapienic acid, stearic acid, oleic acid, elaidic acid, vaccenic acid, linoleic acid, linoelaidic acid, a-linoelaidic acid, arachidic acid, arachidonic acid, eicosapentaenoic acid, behenic acid, erucic acid, and docosahexaenoic acid, and mixtures thereof.

Saturated fatty acids, such as caprylic acid, capric acid, lauric acid, myristic acid, palmitic acid, stearic acid, arachidic acid, behenic acid, and mixtures thereof, are preferred, but not necessary, for the practice of the present invention. Among these saturated fatty acids, lauric acid, myristic acid and palmitic acid are particularly preferred.

When the cleaninig composition is in a concentrated form, especially a concentrated powder or granular form, the fatty acids or salts thereof can be present at a significantly higher level, e.g., from about 4% to about 12%, and preferably from about 5% to about 8%, by total weight of the concentrated cleaning composition.

### Other Surfactants of the Surfactant System

In addition to LAS, mid-cut AS, and fatty acids or salts described hereinabove, the surfactant system employed by the cleaning composition of the present invention may comprise one or more additional surfactant(s) selected from other anionic surfactants, nonionic surfactants, cationic surfactants, ampholytic surfactants, zwitterionic surfactants, semi-polar nonionic surfactants and mixtures thereof.

The cleaning compositions of the invention may comprise additional anionic surfactants which comprise one or more moieties selected from the group consisting of carbonate, phosphate, phosphonate, sulphate, sulfonate, carboxylate and mixtures thereof not disclosed hereinabove. The cleaning compositions of the present invention may comprise one or more non-ionic surfactants in amounts of from about 0.5 wt % to about 20 wt %, and preferably from 2 wt % to about 4 wt % by total weight of the composition. Suitable non-ionic surfactants can be selected from the group consisting of: alkyl polyglucoside and/or an alkyl alkoxylated alcohol; C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 35; alkylcelluloses, specifically alkylpolyglycosides; polyhydroxy fatty acid amides; ether capped poly(oxyalkylated) alcohol surfactants; and mixtures thereof.

The cleaning compositions of the present invention may comprise a cationic surfactant. When present, the composition typically comprises from about 0.05 wt % to about 5 wt %, or from about 0.1 wt % to about 2 wt % of such cationic surfactant. Suitable cationic surfactants are alkyl pyridinium compounds, alkyl quaternary ammonium compounds, alkyl quaternary phosphonium compounds, and alkyl ternary sulfonium compounds. The cationic surfactant can be selected from the group consisting of: alkoxylate quaternary ammonium (AQA) surfactants; dimethyl hydroxyethyl quaternary ammonium surfactants; polyamine cationic surfactants; cationic ester surfactants; amino surfactants, specifically amido propyldimethyl amine; and mixtures thereof. Highly preferred cationic surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride. Cationic surfactants such as Praepagen HY (tradename Clariant) may be useful and may also be useful as a suds booster.

### Water-soluble Alkali Metal Carbonate

The cleaning composition of the present invention, when it is in a powder or granular form, may also contain a water-soluble alkali metal carbonate. Suitable alkali metal carbonate that can be used for practice of the present invention include, but are not limited to, sodium carbonate, potassium carbonate, sodium bicarbonate, and potassium bicarbonate (which are all referred to as “carbonates” or “carbonate” hereinafter). Sodium carbonate or sodium bicarbonate is particularly preferred. Potassium carbonate and potassium bicarbonate can also be used.

Such water-soluble alkali metal carbonate can be present in the cleaning composition at a level ranging from about 1 wt % to about 50 wt %, preferably from about 4 wt % to about 25 wt %, and more preferably from 6 wt % to about 20 wt %. In a most preferred embodiment of the present invention, the cleaning composition of the present invention includes from about 10 wt % to about 15 wt % of sodium carbonate or sodium bicarbonate.

When the cleaninig composition is in a concentrated form, especially a concentrated powder or granular form, the water-soluble alkali metal carbonate will be present at a significantly lower level (i.e., to accommodate the higher surfactant or active level), which may range from about 9% to about 12%, by total weight of the concentrated cleaning composition.

### Alkoxylated Polyalkyleneimine Suds Collapser

The cleaning composition may also include an alkoxylated polyalkyleneimine, which causes the suds to collapse at a predetermined time, typically during the rinse cycle, instead of throughout the entire washing and rinsing duration. Preferably, the suds collapsing is triggered by an event or a condition, for example, a pH change, to cause the suds in the laundry liquor to collapse, burst and/or otherwise remove them from perception at a faster rate than if the suds collapser is not present, or is not activated.

Specifically, the alkoxylated polyalkyleneimine may contain a polyalkyleneimine backbone or core that is modified by replacing one or more hydrogen atoms attached to the nitrogen atoms in such backbone or core with polyoxyalkyleneoxy unit, i.e., -(CₙH₂ₙO)ₓH, while n is an integer ranging from about 1 to about 10, preferably from about 1 to about 5, and more preferably from about 2 to about 4, and x is an integer ranging from 1 to 200, preferably from about 2 to about 100, and more preferably from about 5 to about 50. The polyalkyleneimine backbone or core typically has an average number-average molecular weight (Mwₙ) prior to modification within the range of from about 100 to about 100,000, preferably from about 200 to about 5000, and more preferably from about 500 to about 1000.

More preferably, the alkoxylated polyalkyleneimine suds collapser of the present invention has a polyethyleneimine core with inner polyethylene oxide blocks and outer polypropylene oxide blocks. Specifically, such alkoxylated polyalkyleneimine has an empirical formula of (PEI)ₐ(CH₂CH₂O)_{b}(CH₂CH₂CH₂O)_{c}, while PEI stands for a polyethyleneimine core, while a is the average number-average molecular weight (Mwₙ) prior to modification within the range of from about 100 to about 100,000 Daltons; b is weight average number of ethylene oxide (CH₂CH₂O) units per nitrogen atom in the PEI core, which is an integer ranging from about 0 to about 60; and c is the weight average number of propylene oxide (CH₂CH₂CH₂O) units per nitrogen atom in the PEI core, which is an integer ranging from about 0 to about 60. Preferably, a ranges from about 200 to about 5000 Daltons, and more preferably from about 500 to about 1000 Daltons; preferably b ranges from about 10 to about 50, and more preferably from about 20 to about 40; and preferably c ranges from about 0 to about 60, preferably from about 1 to about 20, and more preferably from about 2 to about 10. Please note that the empirical formula shows only the relative amounts of each of the constituents, and is not intended to indicate the structural order of the different moieties.

The suds collapser is typically present in the cleaning composition at an amount ranging from about 0.05 wt % to about 5 wt %, preferably from about 0.2 wt % to about 3 wt %, more preferably from about 0.3 wt % to about 2 wt %, and most preferably from about 0.35 wt % to about 1 wt % by total weight of the composition. Without intending to be limited by theory, it is believed that the suds collapser herein may reduce initial suds in the rinse by at least about 25%, or from about 25% to about 100%, or from about 50% to about 100%, or from about 60% to about 100%, as compared to when no suds collapser is present.

### Amphiphilic Graft Copolymer(s)

The cleaning composition of the present invention may further include amphiphilic graft copolymers characterized by a polyalkylene oxide (also referred to as poyalkylene glycol) backbone grafted with one or more side chains.

The polyalkylene oxide backbone of the amphiphilic graft copolymers of the present invention may comprise repeated units of C₂-C₁₀, preferably C₂-C₆, and more preferably C₂-C₄, alkylene oxides. For example, the polyalkylene oxide backbone may be a polyethylene oxide (PEO) backbone, a polypropylene oxide (PPO) backbone, a polybutylene oxide (PBO) backbone, or a polymeric backbone that is a linear block copolymer of PEO, PPO, and/or PBO, while the PEO backbone is preferred. Such a polyalkylene oxide backbone preferably has a number average molecular weight of from about 2,000 to about 100,000 Daltons, more preferably from about 4,000 to about 50,000 Daltons, and most preferably from about 5,000 to about 10,000 Daltons.

The one or more side chains of the amphiphilic graft copolymers of the present invention are formed by polymerizations of vinyl esters of C₂-C₁₀, preferably C₂-C₆, and more preferably C₂-C₄, carboxylic acids. For example, the one or more side chains may be selected from the group consisting of polyvinyl acetate, polyvinyl propionate, polyvinyl butyrate, and combinations thereof, while polyvinyl acetate is preferred. The polyvinyl ester side chains may be partially saponified, for example, to an extent of up to 15%. The amphiphilic graft copolymer is preferably characterized by an average of no more than 1 graft site (i.e., the site on the polymeric backbone where a polyvinyl ester side chain is grafted thereto) per 50 alkyleneoxide units on the backbone.

The amphiphilic graft copolymers of the present invention may have an overall mean molar masses (M_{w}) of from about 3000 to about 100,000 Daltons, preferably from about 10,000 to about 50,000 Daltons, and more preferably from about 20,000 to about 40,000 Daltons.

Particularly preferred amphiphilic graft copolymers of the present invention have a polyethylene oxide backbone grafted with one or more side chains of polyvinyl acetate. More preferably, the weight ratio of the polyethylene oxide backbone over the polyvinyl acetate side chains ranges from about 1:0.2 to about 1:10, or from about 1:0.5 to about 1:6, and most preferably from about 1:1 to about 1:5. One example of such preferred amphiphilic graft copolymers is the Sokalan™ HP22 polymer, which is commercially available from BASF Corporation. This polymer has a polyethylene oxide backbone grafted with polyvinyl acetate side chains. The polyethylene oxide backbone of this polymer has a number average molecular weight of about 6,000 Daltons (equivalent to about 136 ethylene oxide units), and the weight ratio of the polyethylene oxide backbone over the polyvinyl acetate side chains is about 1:3. The number average molecular weight of this polymer itself is about 24,000 Daltons.

Preferably, but not necessarily, the amphiphilic graft copolymers of the present invention have the following properties: (i) the surface tension of a 39 ppm by weight polymer solution in distilled water is from about 40 mN/m to about 65 mN/m as measured at 25° C. by a tensiometer; and (ii) the viscosity of a 500 ppm by weight polymer solution in distilled water is from about 0.0009 to about 0.003 Pa. S as measured at 25° C. by a rheometer. The surface tension of the polymer solution can be measured by any known tensiometer under the specified conditions. Non-limiting tensiometers useful herein include Kruss K12 tensiomerter available from Kruss, Thermo DSCA322 tensiometer from Thermo Cahn, or Sigma 700 tensiometer from KSV Instrument Ltd. Similarly, the viscosity of the polymer solution can be measured by any known rheometer under the specified conditions. The most commonly used rheometer is a rheometer with rotational method, which is also called a stress/strain rheometer. Non-limiting rheometers useful herein include Hakke Mars rheometer from Thermo, Physica 2000 rheometer from Anton Paar.

The amphiphilic graft copolymer(s) may be present in the cleaning composition of the present invention in an amount ranging from about 0.3 wt % to about 3 wt % or from about 0.35 wt % to about 2 wt % by total weight of the composition. They are found to provide excellent hydrophobic soil suspension even in the presence of cationic coacervating polymers.

### Cationic Polymers

The cleaning composition of the present invention may further contain one or more cationic polymers having a cationic charge density of from about 0.005 to about 23, from about 0.01 to about 12, or from about 0.1 to about 7 milliequivalents/g, at the pH of intended use of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

Suitable cationic polymers for the practice of the present invention may be synthetic polymers made by polymerizing one or more cationic monomers selected from the group consisting of N,N-dialkylaminoalkyl acrylate, N,N-dialkylaminoalkyl methacrylate, N,N-dialkylaminoalkyl acrylamide, N,N-dialkylaminoalkylmethacrylamide, quaternized N, N dialkylaminoalkyl acrylate quaternized N,N-dialkylaminoalkyl methacrylate, quaternized N,N-dialkylaminoalkyl acrylamide, quaternized N,N-dialkylamino alkylmethacryl amide, Methacryloamidopropyl-pentamethyl-1,3-propylene-2-ol-ammonium dichloride, N,N,N,N′,N′,N″,N″-heptamethyl-N″-3-(1-oxo-2-methyl-2- propenyl)aminopropyl-9- oxo-8-azo-decane-1,4,10-triammonium trichloride, vinylamine, allylamine, vinyl imidazole, quaternized vinyl imidazole, diallyl dialkyl ammonium chloride, and derivatives or combinations thereof, with one or more nonionic monomers selected from the group consisting of acrylamide, N,N-dialkyl acrylamide, methacrylamide, N,N-dialkylmethacrylamide, C₁-C₁₂ alkyl acrylate, C₁-C₁₂ hydroxyalkyl acrylate, polyalkylene glyol acrylate, C₁-C₁₂ alkyl methacrylate, C₁-C₁₂ hydroxyalkyl methacrylate, polyalkylene glycol methacrylate, vinyl acetate, vinyl alcohol, vinyl formamide, vinyl acetamide, vinyl alkyl ether, vinyl pyridine, vinyl pyrrolidone, vinyl imidazole, vinyl caprolactam, and derivatives, acrylic acid, methacrylic acid, maleic acid, vinyl sulfonic acid, styrene sulfonic acid, acrylamidopropylmethane sulfonic acid (AMPS), and derivatives and combinations thereof. The cationic polymer may optionally be branched or cross-linked by using branching and crosslinking monomers.

In another aspect, the cationic polymers may be selected from the group consisting of cationic polysaccharide, polyethyleneimine and its derivatives, poly(acrylamide-co-diallyldimethylammonium chloride), poly(acrylamide-methacrylamidopropyltrimethyl ammonium chloride), poly(acrylamide-co-N,N-dimethyl aminoethyl acrylate) and its quaternized derivatives, poly(acrylamide-co-N,N-dimethyl aminoethyl methacrylate) and its quaternized derivative, poly(hydroxyethylacrylate-co-dimethyl aminoethyl methacrylate), poly(hydroxpropylacrylate-co-dimethyl aminoethyl methacrylate), poly(hydroxpropylacrylate-co-methacrylamidopropyltrimethyl ammonium chloride), poly(acryl amide-co-diallyldimethylammonium chloride-co-acrylic acid), poly(acryl amide-co-diallyldimethylammonium chloride-co-vinyl pyrrolidone), poly(acrylamide-methacrylamidopropyltrimethyl ammonium chloride-co-acrylic acid), poly(diallyldimethyl ammonium chloride), poly(vinylpyrrolidone-co-dimethylaminoethyl methacrylate), poly(ethyl methacrylate-co-quaternized dimethylaminoethyl methacrylate), poly(ethyl methacrylate-co-oleyl methacrylate-co-diethylaminoethyl methacrylate), poly(diallyldimethylammonium chloride-co-acrylic acid), poly(vinyl pyrrolidone-co-quaternized vinyl imidazole) and poly(acrylamide-co-Methacryloamidopropyl-pentamethyl-1,3-propylene-2-ol-ammonium dichloride). Suitable cationic polymers can specifically be selected from the group consisting of Polyquatemium-1, Polyquaternium-5, Polyqu aternium- 6, Polyquaternium-7, Polyquaternium-8, Polyquaternium-11, Polyquatemium- 14 , Polyquaternium-22, Polyquaternium-28, Polyquaternium-30, Polyquaternium-32 and Polyquaternium-33, as named under the International Nomenclature for

Cosmetic Ingredients. A particularly preferred cationic polymer for the practice of the present invention is Polyquarternium-7.

The cationic polymers may contain charge neutralizing anions such that the overall polymer is neutral under ambient conditions. Non-limiting examples of suitable counter ions (in addition to anionic species generated during use) include chloride, bromide, sulphate, methylsulphate, sulfonate, methylsulfonate, carbonate, bicarbonate, formate, acetate, citrate, nitrate, and mixtures thereof.

The weight-average molecular weight of the cationic polymer may be from about 500 to about 5,000,000, or from about 1,000 to about 2,000,000, or from about 2,500 to about 1,500,000 Daltons, as determined by size exclusion chromatography relative to polyethyleneoxide standards with RI detection. In one aspect, the MW of the cationic polymer may be from about 500 to about 300,000 Daltons.

Such cationic polymer can be provided in the amount of from about 0.01 wt % to about 15 wt %, preferably from about 0.05 wt % to about 10 wt %, and more preferably from about 0.1 wt % to about 5 wt % by total weight of the cleaning composition.

### Adjunct Components

The cleaning composition of the present invention may comprise one or more additional adjunct components. The precise nature of these additional adjunct components, and levels of incorporation thereof, will depend on the physical form of the composition and the nature of the operation for which it is to be used. Suitable adjunct materials include, but are not limited to, builders, carriers, structurants, flocculating aid, chelating agents, dye transfer inhibitors, enzymes, enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, hydrotropes, processing aids, and/or pigments.

In a preferred embodiment of the present invention, the cleaning composition of the present invention is a granular laundry detergent composition comprising one or more builders (not including the carbonate as described hereinabove) in the amount ranging from about 1 wt % to about 40 wt %, typically from 2 wt % to 25 wt %, or even from about 5 wt % to about 20 wt %, or from 8 wt to 15 wt % by total weight of such composition. Builders as used herein refers to any ingredients or components that are capable of enhancing or improving the cleaning efficiency of surfactants, e.g., by removing or reducing “free” calcium/magnesium ions in the wash solution to “soften” or reducing hardness of the washing liquor.

It is particularly desirable that such granular laundry detergent composition has relatively low levels of phosphate builder, zeolite builder, and silicate builder. Preferably, it contains at most 15 wt % by weight of phosphate builder, zeolite builder, and silicate builder in total. More preferably, such granualar laundry detergent composition contains from 0 wt % to about 5 wt % of phosphate builder, from 0 wt % to about 5 wt % of zeolite builder, and from 0 wt % to about 10 wt % of silicate builder, while the total amounts of these builders add up to no more than 10 wt % by total weight of the composition. Still more preferably, the granualar laundry detergent composition contains from 0 wt % to about 2 wt % of phosphate builder, from 0 wt % to about 2 wt % of zeolite builder, and from 0 wt % to about 2 wt % of silicate builder, while the total amounts of these builders add up to no more than 5 wt % by total weight of the composition. Most preferably, the granualar laundry detergent composition contains from 0 wt % to about 1 wt % of phosphate builder, from 0 wt % to about 1 wt % of zeolite builder, and from 0 wt % to about 1 wt % of silicate builder, while the total amounts of these builders add up to no more than 2 wt % by total weight of the composition. The composition may further comprise any other supplemental builder(s), chelant(s), or, in general, any material which will remove calcium ions from solution by, for example, sequestration, complexation, precipitation or ion exchange. In particular the composition may comprise materials having at a temperature of 25° C. and at a 0.1M ionic strength a calcium binding capacity of at least 50 mg/g and a calcium binding constant log K Ca²⁺of at least 3.50.

The granular laundry detergent composition of the present invention may contain one or more solid carriers selected from the group consisting of sodium chloride, potassium chloride, sodium sulphate, and potassium sulphate. In a preferred, but not necessary embodiment, such granular laundry detergent composition includes from about 20 wt % to about 65 wt % of sodium chloride and/or from about 20 wt % to about 65 wt % of sodium sulphate. When the granular laundry detergent composition is in a concentrated form, the total amount of sodim chloride and/or sodium sulphate in such composition may sum up, for example, to a total amount of from about 0 wt % to about 60 wt %.

The cleaning composition of the present invention may further comprise one or more suitable detergent ingredients such as transition metal catalysts; imine bleach boosters; enzymes such as amylases, carbohydrases, cellulases, laccases, lipases, bleaching enzymes such as oxidases and peroxidases, proteases, pectate lyases and mannanases; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters and/or terephthalate polymers, polyethylene glycol including polyethylene glycol substituted with vinyl alcohol and/or vinyl acetate pendant groups; perfumes such as perfume microcapsules, polymer assisted perfume delivery systems including Schiff base perfume/polymer complexes, starch encapsulated perfume accords; soap rings; aesthetic particles including coloured noodles and/or needles; dyes; co-polyesters of di-carboxylic acids and diols; cellulosic polymers such as methyl cellulose, carboxymethyl cellulose, hydroxyethoxycellulose, or other alkyl or alkylalkoxy cellulose, and hydrophobically modified cellulose; carboxylic acid and/or salts thereof, including citric acid and/or sodium citrate; and any combination thereof.

### Cleaning Composition

The cleaning composition is typically a laundry detergent composition or a dish washing detergent composition. Typically, the composition is a laundry detergent composition.

The laundry detergent composition may be in the form of a liquid, gel, paste, dispersion, typically a colloidal dispersion or any combination thereof. Liquid compositions typically have a viscosity of from 250 mPa.s to 3,000 mPa.s, when measured at a shear rate of 20 s⁻¹ at ambient conditions (20° C. and 1 atmosphere), and typically have a density of from 800 to 1300 If the composition is in the form of a dispersion, then it will typically have a volume average particle size of from 1 micrometer to 5,000 micrometers, typically from 1 micrometer to 50 micrometers. Typically, a Coulter Multisizer is used to measure the volume average particle size of a dispersion. Liquid compositions may contain cleaning actives solubilised or dispersed in a solvent. Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof. The detergent composition may also be

The laundry detergent composition can also be, and is preferably, in a solid or a particulate form, typically in a free-flowing particulate form. The composition in solid form can be in the form of an agglomerate, granule, flake, extrudate, bar, tablet or any combination thereof. The solid composition can be made by methods such as dry-mixing, agglomerating, compaction, spray drying, pan-granulation, spheronization or any combination thereof. The solid composition typically has a bulk density of from 300 g/l to 1,500 g/l typically from 500 g/l to 1,000 g/l .

The laundry detergent composition may be in unit dose form, including not only tablets, but also unit dose pouches wherein the composition is at least partially enclosed, typically completely enclosed, by a film such as a polyvinyl alcohol film.

The laundry detergent composition may also be in the form of an insoluble substrate, for example a non-woven sheet, impregnated with detergent actives.

The laundry detergent composition may be capable of cleaning and/or softening fabric during a laundering process. Typically, the composition is formulated for use in an automatic washing machine or for hand-washing use, and preferably for hand-wash.

### Methods of Using the Cleaning or Laundry Detergent Composition

The compositions are typically used for cleaning and /or treating a situs inter alia a surface or fabric. As used herein, “surface” may include such surfaces such as dishes, glasses, and other cooking surfaces, hard surfaces, hair or skin. Such method includes the steps of contacting an embodiment of the laundry detergent or cleaning composition, in neat form or diluted in a wash liquor, with at least a portion of a surface or fabric, then optionally rinsing such surface or fabric. The surface or fabric may be subjected to a washing step prior to the aforementioned rinsing step. For purposes of the present invention, “washing” includes but is not limited to, scrubbing, wiping, and mechanical agitation.

The composition solution pH is chosen to be the most complimentary to a target surface to be cleaned spanning broad range of pH, from about 5 to about 11. For personal care such as skin and hair cleaning pH of such composition preferably has a pH from about 5 to about 8 for laundry cleaning compositions pH of from about 8 to about 10. The compositions are preferably employed at concentrations of from about 200 ppm to about 10,000 ppm in solution. The water temperatures preferably range from about 5° C. to about 100° C.

As will be appreciated by one skilled in the art, the laundry detergent of the present invention are ideally suited for use in laundry applications. Accordingly, the present invention includes a method for laundering a fabric. The method may comprise the steps of contacting a fabric to be laundered with a laundry detergent comprising the carboxyl group-containing polymer. The fabric may comprise most any fabric capable of being laundered in normal consumer use conditions. The solution preferably has a pH of from about 8 to about 10.5. The laundry detergent may be employed at concentrations of from about 500 ppm to about 15,000 ppm in solution, and optionally, more dilute wash conditions can be used. The water temperatures typically range from about 5° C. to about 90° C. The water to fabric ratio is typically from about 1:1 to about 30:1.

The method of laundering fabric may be carried out in a top-loading or front-loading automatic washing machine, or can be used in a hand-wash laundry application. In these applications, the wash liquor formed and concentration of laundry detergent composition in the wash liquor is that of the main wash cycle. Any input of water during any optional rinsing step(s) is not included when determining the volume of the wash liquor.

The wash liquor may comprise 40 litres or less of water, or 30 litres or less, or 20 litres or less, or 10 litres or less, or 8 litres or less, or even 6 litres or less of water. The wash liquor may comprise from above 0 to 15 litres, or from 2 litres, and to 12 litres, or even to 8 litres of water. For dilute wash conditions, the wash liquor may comprise 150 litres or less of water, 100 litres or less of water, 60 litres or less of water, or 50 litres or less of water, especially for hand washing conditions, and can depend on the number of rinses.

Typically from 0.01 Kg to 2 Kg of fabric per litre of wash liquor is dosed into the wash liquor. Typically from 0.01 Kg, or from 0.05 Kg, or from 0.07 Kg, or from 0.10 Kg, or from 0.15 Kg, or from 0.20 Kg, or from 0.25 Kg fabric per litre of wash liquor is dosed into the wash liquor. Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the wash liquor.

### EXAMPLES

The following examples are given by way of illustration only and therefore should not be construed to limit the scope of the invention.

### Example 1:

### Comparative Tests Showing Significantly Improved Dissolution of Brigtener 15 in a LAS+Mid-Cut AS+Soap Surfactant System

Eight (8) exemplary granular laundry detergent formulations with different brighteners and different surfactant systems (but the same total surfactant level) are prepared to demonstrate the impact of surfactants and brightener combinations on dissolution of the brighteners. These exemplary formulations include: (1) Formulation A, which contains Florescent Brigthener 260 in a LAS-only surfactant system; (2) Formulation B, which contains Florescent Brigthener 260 in a LAS+mid-cut AS surfactant system; (3) Formulation C, which contains Florescent Brigthener 260 in a LAS+soap surfactant system; (4) Formulation D, which contains Florescent Brigthener 260 in a LAS+mid-cut AS+soap surfactant system; (5) Formulation E, which contains Florescent Brigthener 351 in a LAS-only surfactant system; (6) Formulation F, which contains Florescent Brigthener 351 in a LAS+mid-cut AS surfactant system; (7) Formulation G, which contains Florescent Brigthener 351 in a LAS+soap surfactant system; and (8) Formulation H, which contains Florescent Brigthener 351 in a LAS+mid-cut AS+soap surfactant system. The total surfactant levels for Formulations A-H are maintained the same at 20 wt %. The compositional breakdown of these formulatiosn are shown in Table I:

TABLE I

| Ingredients (wt %) | A | B | C | D | E | F | G | H |
|---|---|---|---|---|---|---|---|---|
| Florescent | 0.14 | 0.14 | 0.14 | 0.14 | 0.00 | 0.00 | 0.00 | 0.00 |
| Brigthener 260 | | | | | | | | |
| Florescent | 0.00 | 0.00 | 0.00 | 0.00 | 0.09 | 0.09 | 0.09 | 0.09 |
| Brigthener 351 | | | | | | | | |
| LAS | 23.53 | 20.59 | 20.59 | 17.65 | 23.53 | 20.59 | 20.59 | 17.65 |
| Mid-Cut AS | 0.00 | 2.94 | 0.00 | 2.94 | 0.00 | 2.94 | 0.00 | 2.94 |
| Soap* | 0.00 | 0.00 | 2.94 | 2.94 | 0.00 | 0.00 | 2.94 | 2.94 |
| Carbonate | 35.29 | 35.29 | 35.29 | 35.29 | 35.29 | 35.29 | 35.29 | 35.29 |
| Zeolite A | 5.88 | 5.88 | 5.88 | 5.88 | 5.88 | 5.88 | 5.88 | 5.88 |
| Sodium Sulfate | Balance | Balance | Balance | Balance | Balance | Balance | Balance | Balance |

*Na salts of fatty acids

Prepare 10 gpg hardness water (Ca:Mg=3:1) and place 1L of such hardness water in each of 8 beakers separately. Weight a 6.12g sample from each of the Formulations A-H hereabove respectively, and put the samples into beakers with hardness water on the maganetic stirrers. Stir for 15 mins to dissolve the sample.

Turn on a UV-vis spectrophotometer, UV-2550 made by Shimadzu (China) Co. Ltd., and calibrate the baseline. Take about 8 ml solution by using a 10m1 injection syringe. Install a 0.45pm filter on the injection syringe for filtering the solution when it is injected out of the syringe. Inject the filtered solution into a sample cuvette of the UV-Vis spectrophotometer. Place the sample cuvette in a measuring position of the UV-Vis spectrophotometer. Read and record the absorbance (ABS) of solutions at a UV wavelength of 350nm respectively. The following equation is used to calculate improvement of dissolution:

Dissolution Improvement =(ABSₛₐₘₚₗₑ−ABS_{reference})/ABSₛₐₘₚₗₑ *100%

The dissolution measurement and calculation results are shown hereinafter:

TABLE II

| | Florescent Brigthener 260 | | | Florescent Brigthener 351 | |
|---|---|---|---|---|---|
| | Dissolution | | | Dissolution | |
| | in Water | Dissolution | | in Water | Dissolution |
| Formulations | (ABS) | Improvement* | Formulations | (ABS) | Improvement** |
| Formula A | 0.13 | 0% | Formula E | 0.62 | 0% |
| (LAS) | | | (LAS) | | |
| Formula B | 0.13 | 0% | Formula F | 0.64 | 3% |
| (LAS + Mid- | | | (LAS + mid-cut | | |
| Cut AS) | | | CAS) | | |
| Formula C | 0.14 | 8% | Formula G | 0.67 | 8% |
| (LAS + Soap) | | | (LAS + Soap) | | |
| Formula D | 0.18 | 38% | Formula H | 0.66 | 6% |
| (LAS + Mid-Cut | | | (LAS + mid-cut | | |
| CAS + Soap) | | | CAS + Soap) | | |

*Improvement over the reference Formulation A
**Improvement over the reference Formulation E

The above results demonstrate that when used in a surfactant system containing LAS, mid-cut AS, and soap, the dissolution of Florescent Brigthener 260 exhibits a significant increase in comparison with that of the control formulation containing a surfactant system with LAS only. Such increase is far greater than the increase observed when only mid-cut AS or only soap is added into the surfactant system, although the total surfactant level mains the same. This shows that the specific combination of LAS, mid-cut AS and soap has a surprising and unexpected impact on the dissolution of Florescent Brigthener 260.

Further, when Florescent Brigthener 351 is used in the same surfactant system containing LAS, mid-cut AS, and soap, the dissolution increase is much less with no significant difference over that observed after adding mid-cut AS or soap. This shows that the specific choice of brighteners also has an important impact on the dissolution.

### Example 2:

### Exemplary Granular Laundry Detergent Compositions

| Ingredients (wt %) | A | B | C | D | E | F | G | H |
|---|---|---|---|---|---|---|---|---|
| LAS | 7 | 9 | 9 | 11 | 12 | 14 | 14 | 10.5 |
| Mid-cut AS or | 2.2 | 1.5 | 1.5 | 2.2 | 1.0 | 1.0 | 0.7 | 0.5 |
| Coconut AS | | | | | | | | |
| Mid-cut AE1S or | 0 | 0.4 | 0 | 0 | 0.4 | 0 | 1 | 0 |
| Coconut AE1S | | | | | | | | |
| Soaps (Na salts | 4 | 3 | 2.5 | 3 | 5.5 | 2.5 | 3 | 3.5 |
| of fatty acids) | | | | | | | | |
| Florescent | 0.2 | 0.1 | 0.3 | 0.5 | 0.8 | 1 | 0.05 | 0.2 |
| Brigthener 260 | | | | | | | | |
| Florescent | 0 | 0 | 0.1 | 0.08 | 0.02 | 0 | 0 | 0.05 |
| Brigthener 351 | | | | | | | | |
| Dimethyl | 0 | 1 | 0 | 0 | 0 | 1 | 0 | 0 |
| hydroxyethyl | | | | | | | | |
| lauryl | | | | | | | | |
| ammonium | | | | | | | | |
| chloride | | | | | | | | |
| Non-Ionic | 1 | 0 | 0 | 1 | 0 | 0.6 | 0 | 0 |
| (C12-14 EO7) | | | | | | | | |
| Zeolite | 0-5 | 0-5 | 0-5 | 0-5 | 0-5 | 0-5 | 0-5 | 0-5 |
| PEI suds collapser | 0.5 | 0 | 2 | 0.5 | 0.5 | 1 | 0.5 | 0.7 |
| Amphiphilic | 1.0 | 0 | 1 | 0 | 0.5 | 0.5 | 0 | 0 |
| graft polymer | | | | | | | | |
| Cationic polymer | 0.5 | 0 | 0.5 | 0 | 0 | 0 | 0.5 | 0 |
| (Polyquartenium 7) | | | | | | | | |
| Protease (54.5 mg/g) | 0-1 | 0-1 | 0-1 | 0-1 | 0-1 | 0-1 | 0-1 | 0-1 |
| Amylase (29.26 mg/g) | 0-1 | 0-1 | 0-1 | 0-1 | 0-1 | 0-1 | 0-1 | 0-1 |
| Xyloglucanase | 0-1 | 0-1 | 0-1 | 0-1 | 0-1 | 0-1 | 0-1 | 0-1 |
| Polymeric | 0-2 | 0-3 | 0-2 | 0-2 | 0-3 | 0-2 | 0-3 | 0-2 |
| dispersing or soil | | | | | | | | |
| release agent(s) | | | | | | | | |
| Bleach and bleach | 0-5 | 4-6 | 2-3 | 0-5 | 4-6 | 2-3 | 4-6 | 2-3 |
| activator | | | | | | | | |
| Silicate | 0-5 | 0-5 | 3-5 | 0-5 | 0-5 | 3-5 | 0-5 | 3-5 |
| Sodium Carbonate | 15-25 | 12-22 | 15-30 | 8-22 | 15-25 | 6-20 | 15-25 | 10-20 |
| Silicone Particle | 0 | 0.5 | 0 | 0 | | 1 | 0 | 0 |
| Sodium Sulfate | balance | balance | balance | 30-70 | balance | balance | 0 | balance |
| Sodium Chloride | 0 | 20-40 | 0 | balance | 0 | 0 | balance | 0 |

### Example 3:

### Exemplary Concentrated Granular Laundry Detergent Compositions

| Ingredients (wt %) | I | II | III | IV | V | VI | VII | VIII |
|---|---|---|---|---|---|---|---|---|
| LAS | 12 | 15 | 15 | 20 | 20 | 25 | 25 | 30 |
| Mid-cut AS or | 3.5 | 2 | 4 | 6 | 4 | 6 | 4 | 1 |
| Coconut AS | | | | | | | | |
| Mid-cut AE1S or | 0 | 0.7 | 0 | 0 | 0.4 | 0 | 1.5 | 0 |
| Coconut AE1S | | | | | | | | |
| Soaps (Na salts | 3 | 6 | 8 | 3 | 6 | 4 | 9 | 6 |
| of fatty acids) | | | | | | | | |
| Florescent Brigthener 260 | 0.05 | 0.1 | 0.2 | 1 | 2 | 1.5 | 0.8 | 0.5 |
| Florescent Brigthener 351 | 0 | 0.08 | 0 | 0.2 | 0 | 0.15 | 0.1 | 0 |
| Dimethyl hydroxyethyl | 0-2 | 0-2 | 0-2 | 0-2 | 0-2 | 0-2 | 0-2 | 0-2 |
| lauryl ammonium chloride | | | | | | | | |
| Non-ionic (C120-14 EO7) | 0-2 | 0-2 | 0-2 | 0-2 | 0-2 | 0-2 | 0-2 | 0-2 |
| Zeolite | 0-15 | 0-15 | 0-15 | 0-15 | 0-15 | 0-15 | 0-15 | 0-15 |
| PEI suds collapser | 0.5 | 0 | 2 | 0.5 | 0.5 | 1 | 0.5 | 0.7 |
| Amphiphilic graft | 1.0 | 0 | 1 | 0 | 0.5 | 0.5 | 0 | 0 |
| polymer | | | | | | | | |
| Cationic polymer | 0.5 | 0 | 0.5 | 0 | 0 | 0 | 1 | 0 |
| (Polyquartenium 7) | | | | | | | | |
| Protease (54.5 mg/g) | 0-15 | 0-15 | 0-15 | 0-15 | 0-15 | 0-15 | 0-15 | 0-15 |
| Amylase (29.26 mg/g) | 0-15 | 0-15 | 0-15 | 0-15 | 0-15 | 0-15 | 0-15 | 0-15 |
| Xyloglucanase | 0-15 | 0-15 | 0-15 | 0-15 | 0-15 | 0-15 | 0-15 | 0-15 |
| Polymeric dispersing or | 0-2 | 0-3 | 0-2 | 0-2 | 0-3 | 0-2 | 0-3 | 0-4 |
| soil release agent(s) | | | | | | | | |
| Bleach and bleach | 0-6 | 0-6 | 0-6 | 0-6 | 0-6 | 0-6 | 0-6 | 0-6 |
| activator | | | | | | | | |
| Silicate | 0-10 | 0-10 | 0-10 | 0-10 | 0-10 | 0-10 | 0-10 | 0-10 |
| Sodium Carbonate | 20-50 | 20-50 | 15-30 | 8-22 | 15-25 | 15-30 | 15-30 | 15-30 |
| Silicone Particle | 0-2 | 0-2 | 0-2 | 0-2 | 0-2 | 0-2 | 0-2 | 0-2 |
| Sodium Sulfate/Chloride | Balance | Balance | Balance | Balance | Balance | Balance | Balance | Balance |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm. ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising:
a) from 6 wt % to 15 wt % of a C₁₀-C₂₀ linear alkylbenzene sulphonate (LAS);
b) from 0.3 wt % to 4 wt % of an alkyl sulphate (AS) having a branched or linear unalkoxylated alkyl group comprising from 6 to 18 carbon atoms, wherein the LAS-to-AS weight ratio is from 3:1 to 30:1;
c) from 1.5 wt % to 6 wt % of one or more fatty acids or salts thereof; and
d) from 0.01 wt % to 1 wt % of a diaminostilbene brightener.

2. The cleaning composition of claim 1, wherein said diaminostilbene brightener is selected from the group consisting of: (1) disodium 4,4′-bis{[4-anilino-6-morpholino-s-triazin-2-yl]-amino}-2,2′-stilbenedisulfonate; (2) disodium 4,4″-bis [(4,6-di-anilino-s-triazin-2-yl)-amino]-2,2′-stilbenedisulfonate; (3) disodium 4,4′-bis {[4- anilino- 6- [bis(2-hydroxyethyl)amino-s-triazin-2-yl]-amino}-2,2′-stilbenedisulfonate; and (4) mixtures thereof, and wherein said diaminostilbene brightener is preferably disodium 4,4′-bis{[4-anilino-6-morpholino-s-triazin-2-yl]-amino}-2,2′-stilbenedisulfonate.

3. The cleaning composition of claim 1, wherein the diaminostilbene brightener is present in said cleaning composition at an amount ranging from 0.02 wt % to 0.5 wt %, and preferably from 0.05 wt % to 0.3 wt %.

4. The cleaning composition according to claim 1, wherein said cleaning composition further comprises from 0.01 wt % to 0.5 wt %, preferably from 0.02 wt % to 0.4 wt %, and more preferably from 0.05 wt % to 0.3 wt %, of a distyrylbiphenyl brightener, and wherein said distyrylbiphenyl brightener is preferably disodium 2,2′-([1,1′-biphenyl]-4,4′-diyldivinylene)bis(benzenesulphonate).

5. The cleaning composition according to claim 1, wherein the LAS-to-AS weight ratio ranges from 4:1 to 24:1, preferably from 4:1 to 20:1, and more preferably from 4:1 to 15:1.

6. The cleaning composition according to claim 1, comprising from 7 wt % to 13 wt % of LAS, and from 0.5 wt % to 3 wt % of AS.

7. The cleaning composition according to claim 1, comprising from 1.5 wt % to 5 wt %, and preferably from 1.5 wt % to 4 wt %, of said one or more fatty acids or salts thereof, wherein said fatty acids or salts thereof are preferably characterized by 10 to 20 carbon atoms, more preferably from 12 to 18 carbon atoms.

8. The cleaning composition according to claim 1, further comprising from 4 wt % to 25 wt %, preferably from 6 wt % to 20 wt %, of a water-soluble alkali metal carbonate, which is preferably sodium carbonate or sodium bicarbonate.

9. The cleaning composition according to claim 1, wherein said cleaning composition is a granular laundry detergent composition comprising from 20 wt % to 65 wt % of sodium chloride and/or from 20 wt % to 65 wt % of sodium sulphate, and wherein said granular laundry detergent composition is characterized by a moisture content of less than 3 wt %.

10. The cleaning composition according to claim 9, wherein said granular laundry detergent composition comprises from 0 wt % to 5 wt % of a zeolite builder, from 0 wt % to 5 wt % of a phosphate builder, and from 0 wt % to 10 wt % of a silicate builder.

11. A granular laundry detergent composition comprising:
a) from 6 wt % to 15 wt % of a C₁₂ linear alkylbenzene sulphonate (LAS);
b) from 0.3 wt % to 4 wt % of an alkyl sulphate (AS) having a branched or linear unalkoxylated alkyl group comprising from 12 to 14 carbon atoms, wherein the LAS-to-AS weight ratio is from 3:1 to 30:1;
c) from 1.5 wt % to 6 wt % of one or more saturated fatty acids or salts thereof comprising from 12 to 18 carbon atoms; and
d) from 0.01 wt % to 1 wt % of disodium 4,4′-bis{[4-anilino-6-morpholino-s-triazin-2-yl]-amino}-2,2′-stilbenedisulfonate,
wherein said composition has a moisture content of no more than 3 wt %.

12. A concentrated granular laundry detergent composition comprising:
a) from 12 wt % to 30 wt % of a C₁₂ linear alkylbenzene sulphonate (LAS);
b) from 0.5 wt % to 8 wt % of an alkyl sulphate (AS) having a branched or linear unalkoxylated alkyl group comprising from 12 to 14 carbon atoms, wherein the LAS-to-AS weight ratio is from 3:1 to 30:1;
c) from 4 wt % to 12 wt % of one or more saturated fatty acids or salts thereof comprising from 12 to 18 carbon atoms; and
d) from 0.05 wt % to 2 wt % of disodium 4,4′-bis{[4-anilino-6-morpholino-s-triazin-2-yl]-amino}-2,2′-stilbenedisulfonate,
wherein said composition has a moisture content of no more than 3 wt %.
